(19) United States
(12) Patent Application Publication
(10) Pub. No.: US 2025/0368069 A1
(43) Pub. Date: Dec. 4, 2025

(54) Charging Control Method, Power Conversion System, and Vehicle

(71) Applicant: Robert Bosch GmbH, Stuttgart (DE)

(72) Inventors: Hao Yu, Shanghai (CN); Tingting Dong, Shanghai (CN); Yutan Zhang, Shanghai (CN); Xudan Liu, Shanghai (CN)

(21) Appl. No.: 19/218,832

(22) Filed: May 27, 2025

(30) Foreign Application Priority Data
May 31, 2024 (CN) 2024 1070 2401.5

(51) Int. Cl. B60L 53/24; B60L 53/62; H02M 1/15

(52) U.S. Cl. CPC B60L 53/24; B60L 53/62; H02M 1/15; B60L 2210/40

(57) ABSTRACT

A charging control method, a power conversion system, and a vehicle are disclosed. The charging control method includes (i) controlling a first power conversion unit to output charging power from an AC power supply to an energy storage device, the first power conversion unit being coupled between the AC power supply and the energy storage device, and (ii) controlling a second power conversion unit to generate decoupling power on an inductor of at least one traction motor to reduce or offset the power ripple in the charging power, the second power conversion unit being coupled between the energy storage device and at least one traction motor. The solution of the present disclosure can effectively reduce or filter out power ripple without the need for large capacitors or other additional circuits, thereby avoiding space occupation and increased costs and also improving the utilization rate of idle equipment.

This application claims priority under 35 U.S.C. § 119 to application no. CN 2024 1070 2401.5, filed on May 31, 2024 in China, the disclosure of which is incorporated herein by reference in its entirety.

The present disclosure relates to the field of charging technology, and more specifically to a charging control method, a power conversion system, and a vehicle.

### BACKGROUND

In an electric drive device, such as an electric vehicle, an external power supply is required to charge a battery or other energy storage device in the electric drive device, and the electric energy stored in the energy storage device is used to drive a motor to realize related functions. For example, an on-board charger (OBC) is typically provided in an electric vehicle, which can convert AC power from a public grid to DC power suitable for in-vehicle batteries, thereby utilizing the power of the in-vehicle battery to drive the vehicle.

Since both the voltage and current provided by external power sources, such as a public grid, are sinusoidal, the power input typically contains double line frequency ripple. The double line frequency ripple can have adverse effects on the battery and charging. For example, it can reduce battery life and affect efficiency. Therefore, it is desirable to reduce or remove the double line frequency ripple during the charging process. Currently, this ripple can be filtered by placing a large capacitor (e.g., in an OBC). However, this type of filter capacitor is large in size and easily damaged during use, which affects the power density and service life of the charging device.

### SUMMARY

In order to at least partially solve the above and other possible problems, examples of the present disclosure provide a charging control method, a power conversion system using the charging control method, and a vehicle encompassing the power conversion system.

According to a first aspect of the present disclosure, a charging control method is provided, comprising: controlling a first power conversion unit to output charging power from the AC power supply to the energy storage device, the first power conversion unit being coupled between the AC power supply and the energy storage device; and controlling a second power conversion unit to generate decoupling power on the inductor of at least one traction motor to reduce or offset the power ripple in the charging power, the second power conversion unit being coupled between the energy storage device and at least one traction motor.

In some examples of the present disclosure, the first power conversion unit comprises a single-stage conversion circuit that integrates rectification, power factor correction, and DC-AC conversion and the second power conversion unit comprises an inverter.

In some examples of the present disclosure, the second power conversion unit comprises a plurality of switch bridge arms, wherein controlling the second power conversion unit to generate decoupling power on the inductor of the at least one traction motor comprises: generating a switch signal for controlling the plurality of switch bridge arms.

In some examples of the present disclosure, the plurality of switch bridge arms comprise a first bridge arm, a second bridge arm, and a third bridge arm, the first bridge arm is coupled to a first phase inductor of the first traction motor, the second bridge arm is coupled to a second phase inductor of the first traction motor, and the third bridge arm is coupled to a third phase inductor of the first traction motor, wherein generating a switch signal comprises: generating a first switch signal for simultaneous use in the upper bridge arm switch device of the first bridge arm and the upper bridge arm switch device of the second bridge arm; generating a second switch signal for simultaneous use in the lower bridge arm switch device of the first bridge arm and the lower bridge arm switch device of the second bridge arm; generating a third switch signal for the upper bridge arm switch device of the third bridge arm; and generating a fourth switch signal for the lower bridge arm switch device of the third bridge arm.

In some examples of the present disclosure, the plurality of switch bridge arms comprise a first bridge arm, a second bridge arm, a third bridge arm, and a fourth bridge arm, the first bridge arm is coupled to a first phase inductor of the first traction motor, the second bridge arm is coupled to a second phase inductor of the first traction motor, the third bridge arm is coupled to a third phase inductor of the first traction motor, and the fourth bridge arm is coupled to a neutral point of a multiphase inductor of the first traction motor, and wherein generating a switch signal includes: generating a first switch signal for simultaneous use in the upper bridge arm switch device of the first bridge arm, the upper bridge arm switch device of the second bridge arm, and the upper bridge arm switch device of the third bridge arm; generating a second switch signal for simultaneous use in the lower bridge arm switch device of the first bridge arm, the lower bridge arm switch device of the second bridge arm, and the lower bridge arm switch device of the third bridge arm; generating a third switch signal for the upper bridge arm switch device of the fourth bridge arm; and generating a fourth switch signal for the lower bridge arm switch device of the fourth bridge arm.

In some examples of the present disclosure, the plurality of switch bridge arms comprise a first bridge arm, a second bridge arm, a third bridge arm, a fourth bridge arm, a fifth bridge arm and a sixth bridge arm, the first bridge arm is coupled to a first phase inductor of the first traction motor, the second bridge arm is coupled to a second phase inductor of the first traction motor, the third bridge arm is coupled to a third phase inductor of the first traction motor, the fourth bridge arm is coupled to a first phase inductor of the second traction motor, the fifth bridge arm is coupled to a second phase inductor of the second traction motor, the sixth bridge arm is coupled to a third phase inductor of the second traction motor, and a neutral point of the three-phase inductor of the first traction motor is coupled to a neutral point of the three-phase inductor of the second traction motor, and wherein generating a switch signal comprises: generating a first switch signal for simultaneous use in the upper bridge arm switch device of the first bridge arm, the upper bridge arm switch device of the second bridge arm, and the upper bridge arm switch device of the third bridge arm; generating a second switch signal for simultaneous use in the lower bridge arm switch device of the first bridge arm, the lower bridge arm switch device of the second bridge arm, and the lower bridge arm switch device of the third bridge arm; generating a third switch signal for simultaneous use in the upper bridge arm switch device of the fourth bridge arm, the upper bridge arm switch device of the fifth bridge arm, and the upper bridge arm switch device of the sixth bridge arm; and generating a fourth switch signal for simultaneous use in the lower bridge arm switch device of the fourth bridge arm, the lower bridge arm switch device of the fifth bridge arm, and the lower bridge arm switch device of the sixth bridge arm.

In some examples of the present disclosure, the charging control method further comprises: acquiring a sensing signal indicative of power ripple in the charging power, and wherein controlling the second power conversion unit to generate decoupling power on the inductor of at least one traction motor comprises: controlling a second power conversion unit based on the acquired sensing signal.

In some examples of the present disclosure, the sensing signal comprises at least one of: an input voltage and current input from the AC power supply to the first power conversion unit or output from the first power conversion unit to the energy storage device.

According to a second aspect of the present disclosure, a power conversion system is provided, comprising: a first power conversion unit suitable for coupling between an AC power supply and an energy storage device and used to charge the energy storage device; a second power conversion unit suitable for coupling between the energy storage device and at least one traction motor and used to drive at least one traction motor; and a control device configured to execute the charging control method according to the first aspect.

According to a third aspect of the present disclosure, a vehicle steering system is provided, comprising: an energy storage device; at least one traction motor; and a power conversion system according to the second aspect.

The Summary is provided in part to introduce a selection of concepts in a simplified form, which will be further described in the embodiments below. The Summary is not intended to identify key or primary features of the disclosure, nor is it intended to limit the scope of the disclosure.

### BRIEF DESCRIPTION OF THE DRAWINGS

The exemplary examples of the present disclosure will be described in further detail in conjunction with accompanying drawings in order to further clarify the above-mentioned and other objectives, features, and advantages of the present disclosure, wherein in the exemplary examples of the present disclosure, the same reference number typically represents the same part.

FIG. 1 shows a schematic block diagram of a charging energy storage circuit and an AC power supply.

FIG. 2A shows a schematic diagram of a vehicle and an AC power supply according to an example of the present disclosure.

FIG. 2B shows a schematic circuit diagram of a vehicle and an AC power supply according to an example of the present disclosure.

FIG. 3 shows a schematic flowchart of a charging control method according to an example of the present disclosure.

FIGS. 5A and 5B respectively show a schematic block diagram and a circuit diagram of a first implementation of a vehicle and an AC power supply according to an example of the present disclosure.

FIGS. 6A and 6B respectively show a schematic block diagram and a circuit diagram of a second implementation of a vehicle and an AC power supply according to an example of the present disclosure.

FIGS. 7A and 7B respectively show a schematic block diagram and a circuit diagram of a third implementation of a vehicle and an AC power supply according to an example of the present disclosure.

### DETAILED DESCRIPTION

The examples of the present disclosure will be described in further detail below with reference to the accompanying drawings. Although examples of the present disclosure are shown in the drawings, it should be understood that the present disclosure can be implemented in various forms and should not be limited to the examples set forth herein. Rather, these examples are provided for the purpose of making the disclosure more thorough and complete and are capable of conveying the scope of the disclosure completely to those skilled in the art. Those skilled in the art can derive alternative technical solutions from the following description without departing from the spirit and scope of protection of the present disclosure.

As used herein, the term “comprise” and variations thereof mean open inclusion, i.e., “including but not limited to”. Unless specifically stated, the term “or” means “and/or”. The term “based on” means “at least partially based on”. The term “an example” means “at least one exemplary example”. Other explicit and implicit definitions may be included below.

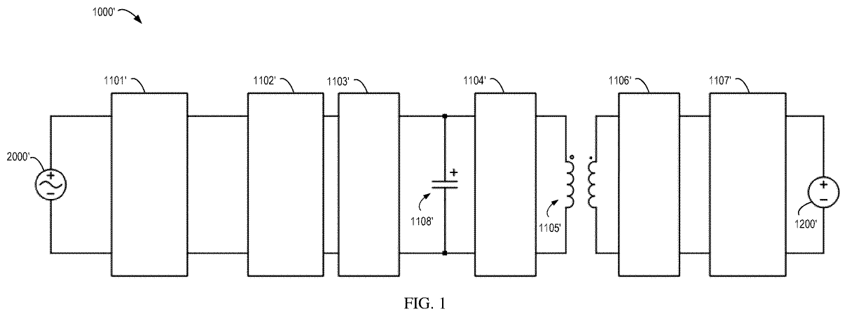

FIG. 1 shows a schematic block diagram of a charging energy storage circuit 1000′ and an AC power supply 2000′. By way of example, the charging energy storage circuit 1000′ may be mounted in the vehicle for charging the vehicle.

As shown in FIG. 1, the charging energy storage circuit 1000′ may comprise an OBC and a battery 1200′, the OBC comprising an EMI filter 1101′, a rectifier 1102′, a power factor correction (PFC) circuit 1103′, a DC-AC circuit 1104′, an isolation transformer 1105′, an AC-DC circuit 1106′, and an output filter 1107′. The OBC of the charging energy storage circuit 1000′ adopts a two-level topology. The first level is an AC-DC conversion level consisting of the rectifier 1102′ and the PFC circuit 1103′ and the second level is a DC-DC conversion level consisting of a DC-AC circuit 1104′, an isolation transformer 1105′, an AC-DC circuit 1106′, and an output filter 1107′. As previously described, the AC power supply 2000′ inputs a double line frequency ripple to the charging energy storage circuit 1000′. For example, where the AC power supply 2000′ is a public grid with a power frequency of 50 Hz, the double line frequency ripple has a frequency greater than 100 Hz. In order to filter out the double line frequency ripple, a large filtering capacitor 1108′ may be installed across the DC bus between the AC-DC conversion stage and the DC-DC conversion stage. Unfortunately, the large filtering capacitor 1108′ has disadvantages such as being relatively large and easily damaged, which results in a reduction in the power density and service life of the OBC.

In addition to the two-level topology, the OBC of the charging energy storage circuit 1000′ can also adopt a single-level topology. The OBC with a single-level topology can integrate the functions of the rectifier 1102′, PFC circuit 1103′, and DC-AC circuit 1104′ together to form a single-stage conversion circuit. The large capacitor 1108′ can be removed in the OBC by employing a single-level topology. The single-level topology can improve the power density, cost, and efficiency of the system, but the presence of double line frequency ripple upon removal of the large capacitor 1108′ will reduce battery 1200′ service life, and battery management systems (BMS) typically do not allow double line frequency ripple to be present. To this end, an active power decoupling circuit can be set in the OBC with a single-level topology to absorb the double line frequency ripple. Such an active power decoupling circuit may be mounted on a line between the OBC and the battery and generally comprises an inductor and a plurality of switches, with both ends of the inductor being coupled to the line between the OBC and the battery via the switches. By controlling these switches, the voltage across the inductor can be adjusted or changed such that a particular current flows through the inductor, whereby the inductor can absorb or release power to balance or counteract the double line frequency ripple of the previous OBC output. By utilizing an additional active power decoupling circuit, the OBC with a single-level topology can output constant and ripple-free DC power to the battery. However, the additional dedicated active power decoupling circuit requires additional high-cost power devices in the OBC, which not only take up space but also result in a significant increase in overall costs.

Examples of the present disclosure provide an improved charging control scheme. In this improved scheme, a traction motor in an electric drive device (e.g., an electric vehicle) and a power converter (e.g., an inverter) driving the traction motor are reused as an active power decoupling circuit to reduce or filter out double line frequency ripple. During the charging process, the power converters of the traction motor and the drive motor are usually in an idle state, so this reuse will not have any impact on the normal use of the electric drive device and can save on large filtering capacitors and dedicated active power decoupling circuits, thereby reducing the overall cost. In addition, since space occupation is reduced and the use of fragile capacitors is avoided, the power density and service life of the electric drive device are effectively increased.

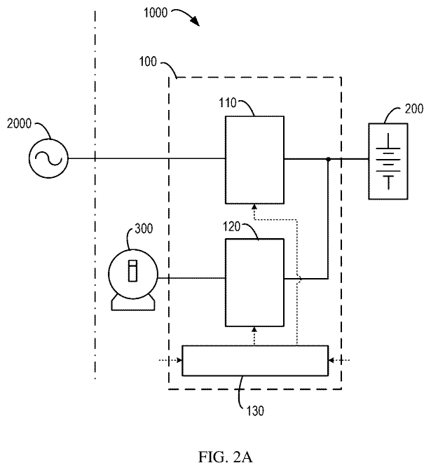

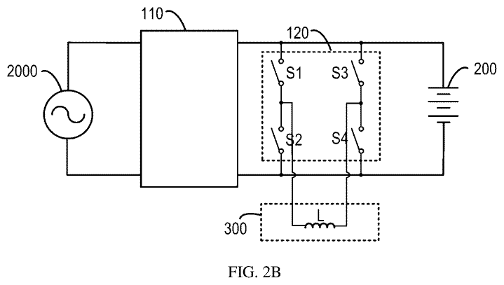

FIG. 2A shows a schematic diagram of a vehicle 1000 and an AC 2000 power supply according to an example of the present disclosure. By way of example, the vehicle 1000 may be an electric vehicle or a hybrid vehicle and the AC power supply 2000 may be a power frequency public grid. As shown in FIG. 2A, the vehicle 1000 may comprise a power conversion system 100, an energy storage device 200, and a traction motor 300. For example, the energy storage device 200 may be a rechargeable battery, a supercapacitor, or a combination thereof and the traction motor 300 may be a permanent magnet synchronous motor or other appropriate type of motor. In addition, the number of motors of the traction motor 300 may be one, two, or more.

The power conversion system 100 comprises a first power conversion unit 110. The first power conversion unit 110 is coupled to the energy storage device 200 and is adapted to couple to an AC power supply 2000. For example, the AC power supply 2000 may be coupled to the first power conversion unit 110 via the vehicle's charging port and/or charging gun when the energy storage device 200 of the vehicle 1000 needs to be charged. The first power conversion unit 110 may be an OBC having a single-level topology. In other words, the first power conversion unit 110 may comprise a single-stage conversion circuit integrating rectification, power factor correction, and DC-AC conversion. It will be understood that the first power conversion unit 110 may also be other appropriate types of power conversion circuits, as long as it can convert the AC power of the AC power supply 2000 into appropriate DC power for charging the energy storage device 200. However, it is preferred that the first power conversion unit 110 adopts an OBC with a single-level topology because the single-level topology structure does not require the use of large capacitors for filtering power ripple and integrates the functions of multiple circuits, so it has a simpler and more compact structure, lower cost, and higher efficiency and power density.

The power conversion system 100 further comprises a second power conversion unit 120. The second power conversion unit 120 is coupled between the energy storage device 200 and the traction motor 300. The second power conversion unit 120 may utilize the electrical energy of the energy storage device 200 to drive the traction motor 300 to drive the wheels of the vehicle 1000 to enable vehicle travel. The second power conversion unit 120 may be an inverter that converts the DC power in the energy storage device 200 to the AC power required for the traction motor 300. However, it will be understood that the second power conversion unit 120 may also be other appropriate types of power conversion circuits as long as power from the energy storage device 200 can be utilized to drive the traction motor 300.

The power conversion system 100 further comprises a control device 130. The control device 130 may be coupled to the first power conversion unit 110 and the second power conversion unit 120 to control the power conversion operations of the first power conversion unit 110 and the second power conversion unit 120. For example, the control device 130 may send a control signal to the switch devices of the first power conversion unit 110 and the second power conversion unit 120 to control the on-off of the switch devices. As an example, the control device 130 may be an in-vehicle electronic control unit (ECU). However, it will be understood that the control device 130 may be any type of processing unit or controller capable of performing operational and/or processing functions. Alternatively, the control device 130 may also be implemented by analog circuitry or digital circuitry, or by any combination of processing units (or controllers), analog circuitry, and digital circuitry. In addition, the control device 130 may be a single controller with integrated functions, or may be a plurality of controllers with dispersed functions, for example, two or more controllers that respectively control the first power conversion unit 110 and the second power conversion unit 120. In the case where the control device 130 comprises a plurality of controllers, the plurality of controllers can be arranged together or distributed in different locations. The examples of the present disclosure do not limit this.

FIG. 2B shows a schematic circuit diagram of a vehicle 1000 and an AC power supply 2000 according to an example of the present disclosure. In FIG. 2B, an equivalent circuit of the second power conversion unit 120 and the traction motor 300 is schematically illustrated. As shown in FIG. 2, by properly operating the second power conversion unit 120, the second power conversion unit 120 may be equivalent to a bridge circuit consisting of switches S1, S2, S3, and S4 and the at least one traction motor 300 may be equivalent to an inductor L. As such, the traction motor 300 and the second power conversion unit 120, which are originally used for driving and traveling of the vehicle 1000, may be reused as active power decoupling circuitry to reduce or filter out the double line frequency ripple.

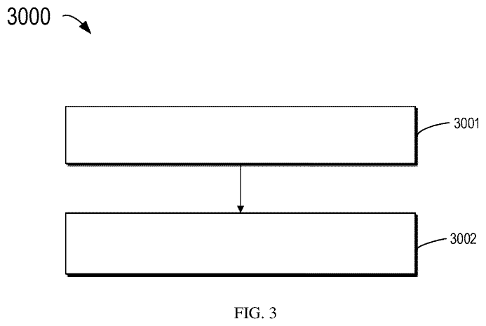

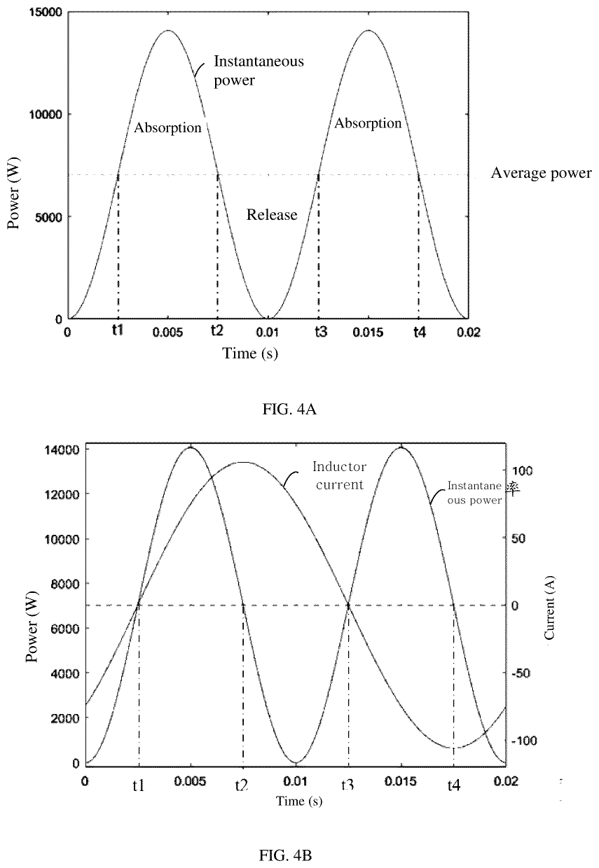

FIG. 3 shows a schematic flowchart of a charging control method 3000 according to an example of the present disclosure. The method 3000 may be implemented in the vehicle 1000 and its power conversion system 100 shown in FIG. 1 and executed by the control device 130 in FIG. 1. Various aspects described above with respect to FIGS. 1 and 2 may be applicable to the method 3000. For purposes of discussion, the method 3000 is described below in conjunction with FIGS. 1 and 2. It is to be noted that, in addition to being applied to the vehicle 1000, the control method 3000 can also be applied to other types of electric drive equipment as long as it has a double line frequency ripple problem and has a traction motor and a power conversion circuit or power conversion unit for driving the traction motor.

At block 3001, the control device 130 controls the first power conversion unit 110 to output charging power from the AC power supply 2000 to the energy storage device 200. In particular, the control device 130 can control the on-off of the switch device in the first power conversion unit 110 to convert the AC power of the AC power supply 2000 to the DC power suitable for the energy storage device 200.

At block 3002, the control device 130 controls the second power conversion unit 120 to generate decoupling power on the inductor L of the at least one traction motor 300 to reduce or offset power ripple in the charging power. Specifically, during the period when the first power conversion unit 110 is charging the energy storage device 200, the second power conversion unit 120 and the traction motor 300 are in an idle state and do not need to drive the vehicle. Therefore, the control device 130 can start and control the second power conversion unit 120 so that the second power conversion unit 120 and the traction motor 300 operate as an active power decoupling circuit to reduce or filter out the double line frequency ripple in the charging power. In this way, there is no need to install large filtering capacitors that are bulky and easily damaged, nor is there a need to install additional dedicated active power decoupling circuits.

By way of example only, the AC power supply 2000 may be a single-phase AC power supply, and the input voltage ₗᵢₖₑ(t) and input current ₗᵢₖₑ(t) of the AC power supply 2000 may be expressed as follows:

$${i}_{phase} ( t ) = \sqrt{2} * {I}_{phase} * sin ( 2 * π * {f}_{AC} * t ) \qquad ( 1 )$$

$${u}_{phase} ( t ) = \sqrt{2} * {U}_{phase} * sin ( 2 * π * {f}_{AC} * t ) \qquad ( 2 )$$

where ᵤₚₕₐₛₑ is a valid value for the input voltage (e.g., 220V), _{Iphase} is a valid value for the input current (e.g., 16 A or 32 A), and f_{AC} is the power supply frequency (e.g., 50 Hz to 60 Hz). As such, the input power of the AC power supply 2000 may be expressed as:

$${p}_{phase} ( t ) = {u}_{phase} ( t ) * {i}_{phase} ( t ) = {U}_{phase} * {I}_{phase} - {U}_{phase} * {I}_{phase} * cos ( 2 * π * 2 * {f}_{AC} * t ) \qquad ( 3 )$$

As can be seen from Equation (3), the input power is the superposition of the DC power Uₚₕₐₛₑ*Iₚₕₐₛₑ and the AC ripple with double line frequency Uₚₕₐₛₑ*Iₚₕₐₛₑ*COS(2*π*2*f_{AC}*t). Where the power supply frequency is from 50 Hz to 60 Hz and the double line frequency is approximately 100 Hz to 120 Hz. In order to counteract or absorb the AC ripple, the control device 130 may control the second power conversion unit 120 to generate decoupling power on the equivalent inductor L of the traction motor 300. The equivalent inductor L of the traction motor 300 will be used as an energy storage element to absorb and release the AC ripple of the OBC in each cycle. The energy W stored by the inductor L of the traction motor 300 is correlated with the inductance value and current and an equation can be used to

$$W = \frac{1}{2} * L * {i}^{2}$$

calculate the instantaneous energy W, where i is the current flowing through the inductor L.

FIG. 4A shows an exemplary waveform of an instantaneous input power and average input power of an AC power supply 2000 according to an example of the present disclosure and FIG. 4B shows an exemplary waveform of an instantaneous input power of an AC power supply 2000 and an inductor current of a traction motor 300 according to an example of the present disclosure. As shown in FIGS. 4A and 4B, for the output ripple of the OBC, the portion of the instantaneous power above the average power needs to be absorbed by the inductor L of the traction motor 300, while the portion of the instantaneous power below the average power needs to be released from the inductor L of the traction motor 300. During t1−t2, the current i in the inductor L of the traction motor 300 increases due to the increase of stored energy, with the current i at time t1 being 0 and the current i at time t2 increasing to the maximum value. During t2−t3, the energy stored in the inductor L of the traction motor 300 is gradually released to supplement the portion of the OBC power that is less than the average power. As a result, the current i of the inductor L gradually decreased and the current i at time t3 reaches 0. In order for the energy stored in the inductor L of the traction motor 300 to always equal the fluctuating power of the OBC, the current i of the inductor L of the traction motor 300 should meet the following equation:

$$\frac{1}{2} * L * {{i}_{L} ( t )}^{2} = {\int }_{t 1}^{t} [ {p}_{phase} ( t ) - {U}_{phase} * {I}_{phase} ] dt \qquad ( 4 )$$

By transforming and simplifying Equation (4), the instantaneous value i L(t) of current i on the inductor L may be expressed by the following equation:

$${i}_{L} ( t ) = \sqrt{\frac{{U}_{phase} * {I}_{phase}}{π * {f}_{AC} * L}} sin ( 2 * π * {f}_{AC} * t - \frac{π}{4} ) \qquad ( 5 )$$

As such, the control device 130 may determine the current required to be applied to the inductor L for eliminating the power ripple, thereby generating decoupling power capable of balancing the power ripple by controlling the switch device of the second power conversion unit 120 (e.g., controlling the duty cycle of switches S1 to S4).

In some examples of the present disclosure, the control device 130 may also acquire a sensing signal indicative of a power ripple in the charging power and control the second power conversion unit 120 based on the acquired sensing signal. In this way, the control device 130 can acquire the generation of the double line frequency ripple in the charging process in real time and therefore operate the second power conversion unit 120 appropriately to balance the double line frequency ripple in the charging power.

In one example, the acquired sensing signal may comprise an input voltage and current input from the AC power supply 2000 to the first power conversion unit 110. The control device 130 can determine the power ripple that needs to be eliminated based on the sensed input voltage Uₚₕₐₛₑ(t) and input current iphase(t), for example, through Equations (1) to (6), and control the second power conversion unit 120 to perform appropriate power conversion to generate corresponding decoupling power on the inductor L of the traction motor 300. In another example, the acquired sensing signal may comprise an output voltage and current output from the first power conversion unit 110 to the energy storage device 200. The control device 130 may determine the power ripple to be output to the energy storage device 200 according to the output voltage and output current of the first power conversion unit 110 and control the second power conversion unit 120 by closed-loop control to control the power ripple to zero, thereby reducing or filtering the ripple.

Alternatively, the control device 130 may also control the second power conversion unit 120 without acquiring the sensing signal according to predetermined settings. For example, the control device 130 may predetermine or calculate the power ripple (e.g., by Equations (1) to (6)) based on the predicted power supply state (e.g., voltage, frequency, and phase) of the public power grid and the control settings of the first power conversion unit 120 to control the second power conversion unit 120 according to the predetermined or calculated power ripple.

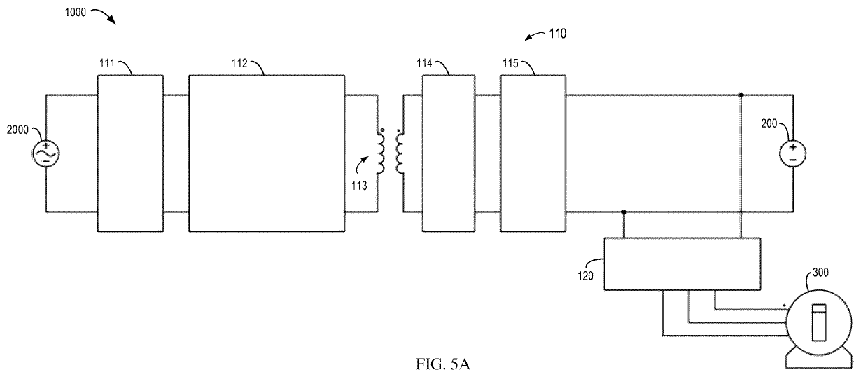

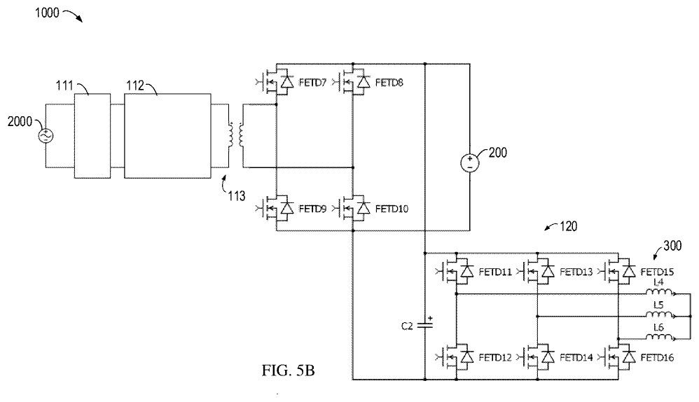

In some examples of the present disclosure, the second power conversion unit 120 comprises a plurality of switch bridge arms and the control device 130 generates a switch signal for controlling the plurality of switch bridge arms. By controlling the plurality of switch bridge arms, the circuit of the plurality of the switch bridge arms can be equivalent to the bridge circuit shown in box 120 in FIG. 2B, thereby realizing the function of an active power decoupling circuit. Exemplary description of how to generate a switch signal for controlling a plurality of switch bridge arms is given below in conjunction with FIGS. 5A, 5B, 6A, 6B, 7A, and 7B.

FIGS. 5A and 5B respectively show a schematic block diagram and a circuit diagram of a first implementation of a vehicle 1000 and an AC power supply 2000 according to an example of the present disclosure. As shown in FIG. 5A, the first power conversion unit 110 may comprise an EMI filter circuit 111, a single-stage conversion circuit 112, an isolation transformer 113, an AC-DC circuit 114, and a filter 115, wherein the single-stage conversion circuit 112 is a single-stage circuit integrating rectification, PFC, and DC-AC conversion and there is no need to set the large filtering capacitor 1108′ in FIG. 1. In addition, the second power conversion unit 120 comprises a three-phase inverter for driving the three-phase traction motor 300. In FIG. 5B, the circuit structures of the first power conversion unit 110, the second power conversion unit 120, and the traction motor 300 are shown in greater detail. The first power conversion unit 110 comprises switch devices FET D7 to FET D10 on the secondary side of the isolation transformer 113.

As shown in FIGS. 5A and 5B, the second power conversion unit 120 comprises three switch bridge arms, i.e., a first bridge arm consisting of switch devices FET D11 and FET D12, a second bridge arm consisting of switch devices FET D13 and FET D14, and a third bridge arm consisting of switch devices FET D15 and FET D16. The three-phase traction motor 300 comprises three phase inductors L4, L5, and L6. For example, the three phase inductors L4, L5, and L6 may be three-phase inductors formed by stator winding or three-phase inductors formed by stator winding and rotor winding. The first bridge arm is coupled to the first phase inductor L4, the second bridge arm is coupled to the second phase inductor L5, and the third bridge arm is coupled to the third phase inductor L6.

During the charging process, the second power conversion unit 120 and the traction motor 300 may be used as an active power decoupling circuit. In performing such operations, the control device 130 may generate a first switch signal for both the upper bridge arm switch device FET D11 of the first bridge arm and the upper bridge arm switch device FET D13 of the second bridge arm and generate a second switch signal for simultaneous use in the lower bridge arm switch device FET D12 of the first bridge arm and the lower bridge arm switch device FET D14 of the second bridge arm. In addition, the control device 130 also generates a third switch signal for the upper bridge arm switch device FET D15 of the third bridge arm and a fourth switch signal for the lower bridge arm switch device FET D16 of the third bridge arm.

Since the switch devices FET D11 and FET D13 are controlled simultaneously with the same control signal, the combination of the switch devices FET D11 and FET D13 may be equivalent to the switch S1 in FIG. 2B. Since the switch devices FET D12 and FET D14 are controlled simultaneously with the same control signal, the combination of the switch devices FET D12 and FET D14 may be equivalent to the switch S2 in FIG. 2B. In addition, the switch device FET D15 is equivalent to switch S3 in FIG. 2B and the switch device FET D16 is equivalent to switch S4 in FIG. 2B. The nodes where the first bridge arm and the second bridge arm are connected to the phase inductors have the same potential, so the first phase inductor L4 and the second phase inductor L5 are equivalent to being connected in parallel. As such, the equivalent inductor L of the traction motor 300 may be expressed as:

$$L = \frac{{L}_{4} * {L}_{5}}{{L}_{4} + {L}_{5}} + {L}_{6} \qquad ( 6 )$$

The above combinations of switch devices are merely exemplary and other similar combinations may be employed. For example, the same signal may be simultaneously applied to both the switch devices FET D11 and FET D15 and the other signal to both the switch devices FET D12 and FET D16 so that the switch devices FET D11 and FET D15 are equivalent to switch S1 and the switch devices FET D12 and FET D16 are equivalent to switch S2, whereby switch device FET D13 is equivalent to switch S3 and switch device FET D14 is equivalent to switch S4.

In this way, the traction motor 300 and the three-phase inverter for driving the traction motor 300 may be reused as an active power decoupling circuit to generate decoupling power for offsetting power ripple. This control method is simple and reliable and does not add to system costs. In addition, since the traction motor 300 and the three-phase inverter for driving the traction motor 300 are in an idle state during charging, such reuse also improves the utilization rate of the equipment.

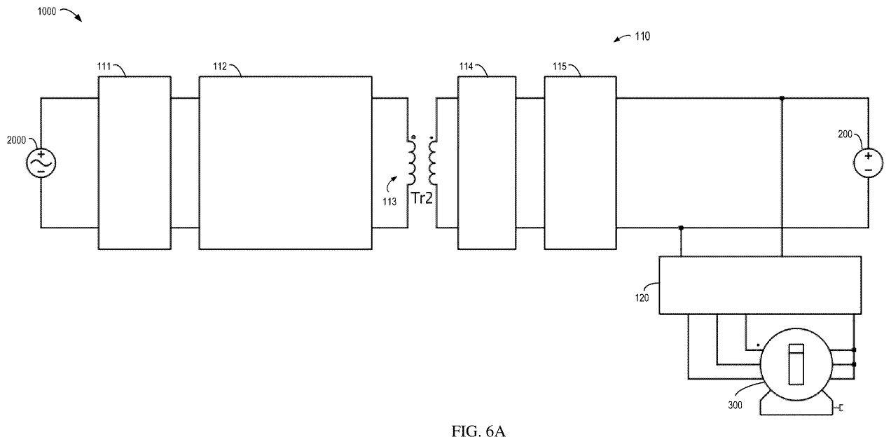

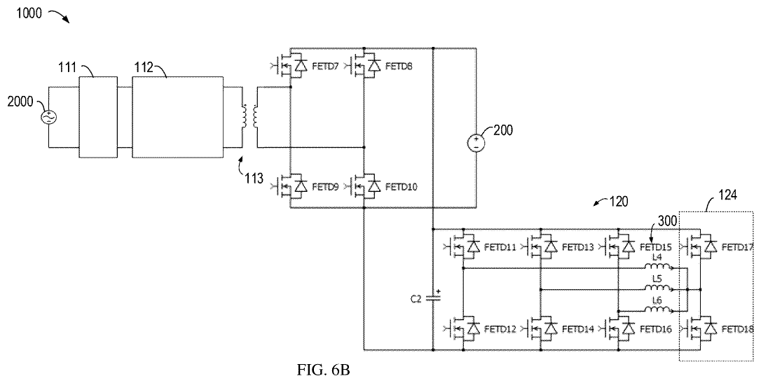

FIGS. 6A and 6B respectively show a schematic block diagram and a circuit diagram of a second implementation of a vehicle 1000 and an AC power supply 2000 according to an example of the present disclosure. Unlike FIGS. 5A and 5B, the second power conversion unit 120 in FIGS. 6A and 6B further comprises a fourth bridge arm 124 consisting of switch devices FET D17 and FET D18, the fourth bridge arm 124 being coupled to a neutral point of a multiphase inductor of the traction motor 300. By way of example, the traction motor 300 here may be an open-winding permanent magnetic synchronous motor (Open-Winding PMSM).

In some types of vehicles, such a fourth bridge arm may be provided in an inverter that drives the traction motor. During the charging process, the second power conversion unit 120 with a fourth bridge arm and the traction motor 300 may be used as an active power decoupling circuit. In performing such operations, the control device 130 may generate a first switch signal for simultaneous use in the upper bridge arm switch device FET D11 of the first bridge arm, the upper bridge arm switch device FET D13 of the second bridge arm, and the upper bridge arm switch device FET D15 of the third bridge arm and generate a second switch signal for simultaneous use in the lower bridge arm switch device FET D12 of the first bridge arm, the lower bridge arm switch device FET D14 of the second bridge arm, and the lower bridge arm switch device FET D16 of the third bridge arm. In addition, the control device 130 generates a third switch signal for the upper bridge arm switch device FET D17 of the fourth bridge arm 124 and a fourth switch signal for the lower bridge arm switch device FET D18 of the fourth bridge arm 124.

The combination of the switch devices FET D11, FET D13, and FET D15 is equivalent to switch S1 in FIG. 2B due to the simultaneous control with the same control signal of the switch devices FET D11, FET D13, and FET D15. The combination of the switch devices FET D12, FET D14, and FET D16 is equivalent to switch S2 in FIG. 2B due to the simultaneous control with the same control signal of the switch devices FET D12, FET D14, and FET D16. In addition, the switch device FET D17 is equivalent to switch S3 in FIG. 2B and the switch device FET D18 is equivalent to switch S4 in FIG. 2B. The nodes where the first bridge arm, the second bridge arm, and the third bridge arm are connected to the phase inductors have the same potential, so the first phase inductor L4, the second phase inductor L5 and the third phase inductor L6 are equivalent to being connected in parallel. As such, the equivalent inductor L of the traction motor 300 may be expressed as:

$$L = 1 / ( 1 / {L}_{4} + 1 / {L}_{5} + 1 / {L}_{6} ) \qquad ( 7 )$$

In this way, the inverter with a fourth bridge arm and the traction motor can be reused as an active power decoupling circuit to avoid the use of large capacitors and dedicated active power decoupling circuits to filter out power ripple, thereby solving the power ripple problem in a low-cost, simple, reliable and space-saving manner. Moreover, such reuse also improves the utilization rate of the inverter and traction motor.

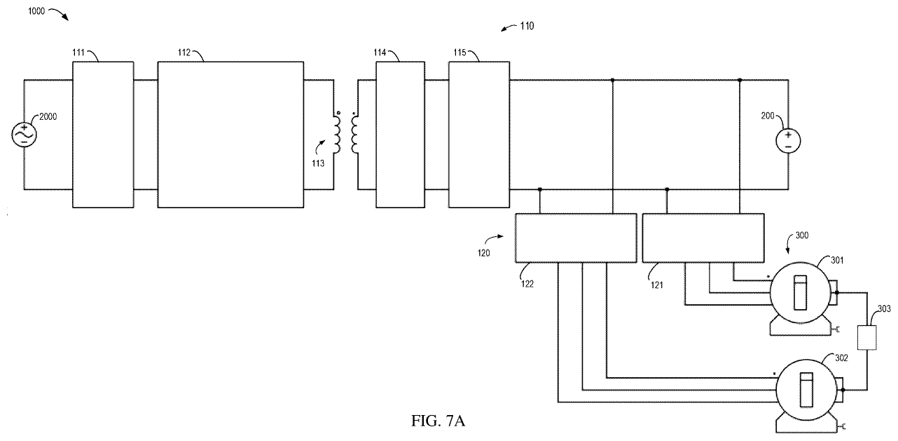

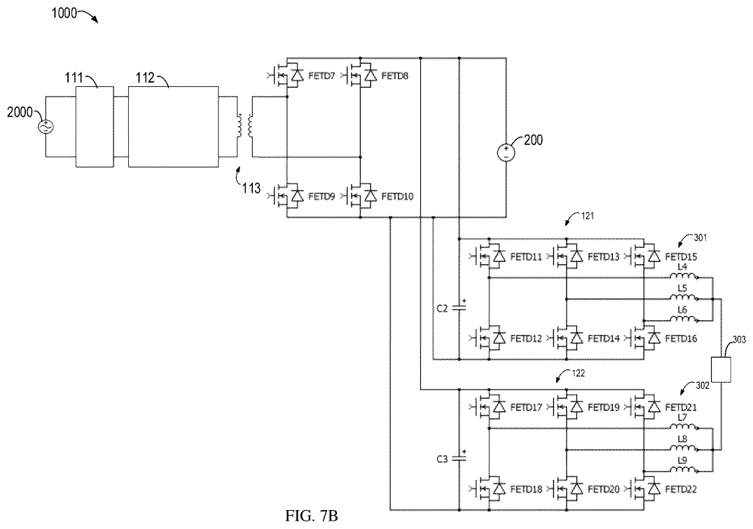

FIGS. 7A and 7B respectively show a schematic block diagram and a circuit diagram of a third implementation of a vehicle 1000 and an AC power supply 2000 according to an example of the present disclosure. Unlike FIGS. 5A and 5B, the second power conversion unit 120 of FIGS. 7A and 7B has two three-phase inverters 121 and 122 for driving two traction motors 301 and 302, respectively.

By way of example, the traction motor 300 here may be an open-winding permanent magnetic synchronous motor (Open-Winding PMSM). In one example, the traction motors 301 and 302 may be electrically connected by an electrical switch 303 (e.g., a relay), and the electrical switch 303 is turned on during vehicle charging to couple the two traction motors 301 and 302, while the electrical switch 303 is turned off during vehicle driving to decouple the two traction motors 301 and 302 from each other.

The inverter 121 of the second power conversion unit 120 comprises three switch bridge arms, i.e., a first bridge arm consisting of switch devices FET D11 and FET D12, a second bridge arm consisting of switch devices FET D13 and FET D14, and a third bridge arm consisting of switch devices FET D15 and FET D16. The inverter 122 of the second power conversion unit 120 comprises three additional switch bridge arms, i.e., a fourth bridge arm consisting of switch devices FET D17 and FET D18, a fifth bridge arm consisting of switch devices FET D19 and FET D20, and a sixth bridge arm consisting of switch devices FET D21 and FET D22. The traction motor 301 comprises three phase inductors L4, L5, and L6 coupled to the first bridge arm, the second bridge arm, and the third bridge arm, respectively. The traction motor 302 comprises three additional phase inductors L7, L8, and L9 coupled to the fourth bridge arm, the fifth bridge arm, and the sixth bridge arm, respectively. In addition, the neutral points of the three-phase inductors of the two traction motors are coupled to one another. The inverters 121 and 122 may further comprise capacitors C2 and C3, respectively.

In some types of vehicles, a plurality of traction motors and a plurality of inverters for driving the plurality of traction motors may be provided. During the charging process, the plurality of inverters and the plurality of traction motors may be used as active power decoupling circuits. In performing such operations, the control device 130 may generate a first switch signal for simultaneous use in the upper bridge arm switch device FET D11 of the first bridge arm, the upper bridge arm switch device FET D13 of the second bridge arm, and the upper bridge arm switch device FET D15 of the third bridge arm and generate a second switch signal for simultaneous use in the lower bridge arm switch device FET D12 of the first bridge arm, the lower bridge arm switch device FET D14 of the second bridge arm, and the lower bridge arm switch device FET D16 of the third bridge arm. In addition, the control device 130 further generates a third switch signal for simultaneous use in the upper bridge arm switch device FET D17 of the fourth bridge arm, the upper bridge arm switch device FET D19 of the fifth bridge arm, and the upper bridge arm switch device FET D21 of the sixth bridge arm and generates a fourth switch signal for simultaneous use in the lower bridge arm switch device FET D18 of the fourth bridge arm, the lower bridge arm switch device FET D20 of the fifth bridge arm, and the lower bridge arm switch device FET D22 of the sixth bridge arm.

The combination of the switch devices FET D11, FET D13, and FET D15 is equivalent to switch S1 in FIG. 2B due to the simultaneous control with the same control signal of the switch devices FET D11, FET D13, and FET D15. The combination of the switch devices FET D12, FET D14, and FET D16 is equivalent to switch S2 in FIG. 2B due to the simultaneous control with the same control signal of the switch devices FET D12, FET D14, and FET D16. The combination of the switch devices FET D17, FET D19, and FET D21 is equivalent to switch S3 in FIG. 2B due to the simultaneous control with the same control signal of the switch devices FET D17, FET D19, and FET D21. The combination of the switch devices FET D18, FET D20, and FET D22 is equivalent to switch S4 in FIG. 2B due to the simultaneous control with the same control signal of the switch devices FET D18, FET D20, and FET D22. In addition, the nodes where the first bridge arm, the second bridge arm, and the third bridge arm of the inverter 121 are connected to the phase inductors have the same potential, so the first phase inductor L4, the second phase inductor L5 and the third phase inductor L6 are equivalent to being connected in parallel. The nodes where the fourth bridge arm, the fifth bridge arm, and the sixth bridge arm of the inverter 122 are connected to the phase inductors have the same potential, so the fourth phase inductor L7, the fifth phase inductor L8 and the sixth phase inductor L9 are equivalent to being connected in parallel. As such, the equivalent inductor L of the traction motor 300 may be expressed as:

$$L = 1 / ( 1 / {L}_{4} + 1 / {L}_{5} + 1 / {L}_{6} ) + 1 / ( 1 / {L}_{7} + 1 / {L}_{8} + 1 / {L}_{9} ) \qquad ( 8 )$$

In this way, a plurality of inverters and a plurality of traction motors can be reused as an active power decoupling circuit to avoid the use of large capacitors and dedicated active power decoupling circuits to filter out power ripple, thereby solving the power ripple problem in a low-cost, simple, reliable and space-saving manner. Moreover, such reuse also improves the utilization rate of these inverters and traction motors.

It will be understood that the above embodiments and corresponding control method are merely exemplary and the control method (such as the combination of switch bridge arms and switch devices thereof) can be adjusted according to the actual situation and needs so long as the desired decoupling power can be generated on the equivalent inductor of the traction motor.

Many modifications and other embodiments of the present disclosure set forth herein will come to mind to one skilled in the art to which the present disclosure pertains given herein in view of the teachings presented in the foregoing descriptions and the associated drawings. Accordingly, it is to be understood that embodiments of the present disclosure are not limited to the specific embodiments disclosed and that modifications and other embodiments are intended to be included within the scope of the present disclosure. Furthermore, while the above description and the accompanying drawings describe example implementations in the context of certain example combinations of components and/or functions, it should be appreciated that different combinations of components and/or functions may be provided by alternative implementations without departing from the scope of the present disclosure. In this regard, for example, other combinations of components and/or functionality than those explicitly described above are also contemplated to be within the scope of the present disclosure. Although specific terms are used herein, they are used only in a general and descriptive sense and are not intended to be limiting.

What is claimed is:

1. A charging control method, comprising:
controlling a first power conversion unit to output charging power from an AC power supply to an energy storage device, the first power conversion unit being coupled between the AC power supply and the energy storage device; and
controlling a second power conversion unit to generate decoupling power on an inductor of at least one traction motor to reduce or offset the power ripple in the charging power, the second power conversion unit being coupled between the energy storage device and at least one traction motor.

2. The charging control method according to claim 1, wherein the first power conversion unit comprises a single-stage conversion circuit that integrates rectification, power factor correction, and DC-AC conversion, and the second power conversion unit comprises an inverter.

3. The charging control method according to claim 1, wherein the second power conversion unit comprises a plurality of switch bridge arms, and wherein controlling the second power conversion unit to generate decoupling power on the inductor of the at least one traction motor comprises:
generating a switch signal for controlling the plurality of switch bridge arms.

4. The charging control method according to claim 3, wherein the plurality of switch bridge arms comprise a first bridge arm, a second bridge arm, and a third bridge arm, the first bridge arm being coupled to a first phase inductor of the first traction motor, the second bridge arm being coupled to a second phase inductor of the first traction motor, and the third bridge arm being coupled to a third phase inductor of the first traction motor, and wherein generating the switch signal comprises:
generating a first switch signal for simultaneous use in the upper bridge arm switch device of the first bridge arm and the upper bridge arm switch device of the second bridge arm;
generating a second switch signal for simultaneous use in the lower bridge arm switch device of the first bridge arm and the lower bridge arm switch device of the second bridge arm;
generating a third switch signal for the upper bridge arm switch device of the third bridge arm; and
generating a fourth switch signal for the lower bridge arm switch device of the third bridge arm.

5. The charging control method according to claim 3, wherein the plurality of switch bridge arms comprise a first bridge arm, a second bridge arm, a third bridge arm, and a fourth bridge arm, the first bridge arm being coupled to a first phase inductor of the first traction motor, the second bridge arm being coupled to a second phase inductor of the first traction motor, the third bridge arm being coupled to a third phase inductor of the first traction motor, and the fourth bridge arm being coupled to a neutral point of a multiphase inductor of the first traction motor, and wherein generating the switch signal comprises:
generating a first switch signal for simultaneous use in the upper bridge arm switch device of the first bridge arm, the upper bridge arm switch device of the second bridge arm, and the upper bridge arm switch device of the third bridge arm;
generating a second switch signal for simultaneous use in the lower bridge arm switch device of the first bridge arm, the lower bridge arm switch device of the second bridge arm, and the lower bridge arm switch device of the third bridge arm;
generating a third switch signal for the upper bridge arm switch device of the fourth bridge arm; and
generating a fourth switch signal for the lower bridge arm switch device of the fourth bridge arm.

6. The charging control method according to claim 3, wherein the plurality of switch bridge arms comprise a first bridge arm, a second bridge arm, a third bridge arm, a fourth bridge arm, a fifth bridge arm and a sixth bridge arm, the first bridge arm being coupled to a first phase inductor of the first traction motor, the second bridge arm being coupled to a second phase inductor of the first traction motor, the third bridge arm being coupled to a third phase inductor of the first traction motor, the fourth bridge arm being coupled to a first phase inductor of the second traction motor, the fifth bridge arm being coupled to a second phase inductor of the second traction motor, the sixth bridge arm being coupled to a third phase inductor of the second traction motor, and a neutral point of the three-phase inductor of the first traction motor being coupled to a neutral point of the three-phase inductor of the second traction motor, and wherein generating the switch signal comprises:
generating a first switch signal for simultaneous use in the upper bridge arm switch device of the first bridge arm, the upper bridge arm switch device of the second bridge arm, and the upper bridge arm switch device of the third bridge arm;
generating a second switch signal for simultaneous use in the lower bridge arm switch device of the first bridge arm, the lower bridge arm switch device of the second bridge arm, and the lower bridge arm switch device of the third bridge arm;
generating a third switch signal for simultaneous use in the upper bridge arm switch device of the fourth bridge arm, the upper bridge arm switch device of the fifth bridge arm, and the upper bridge arm switch device of the sixth bridge arm; and
generating a fourth switch signal for simultaneous use in the lower bridge arm switch device of the fourth bridge arm, the lower bridge arm switch device of the fifth bridge arm, and the lower bridge arm switch device of the sixth bridge arm.

7. The charging control method according to claim 1, further comprising acquiring a sensing signal indicative of power ripple in the charging power, wherein controlling the second power conversion unit to generate decoupling power on the inductor of at least one traction motor comprises:
controlling the second power conversion unit based on the acquired sensing signal.

8. The charging control method according to claim 7, wherein the sensing signal comprises at least one of: an input voltage and current from the AC power supply to the first power conversion unit or an output voltage and current from the first power conversion unit to the energy storage device.

9. A power conversion system, comprising:
a first power conversion unit suitable for coupling between an AC power supply and an energy storage device and used to charge the energy storage device;
a second power conversion unit suitable for coupling between the energy storage device and at least one traction motor and used to drive the at least one traction motor; and
a control device configured to execute the charging control method according to claim 1.

10. A vehicle, comprising:
an energy storage device;
at least one traction motor; and
the power conversion system according to claim 9.
